(19) United States
(12) Patent Application Publication
(10) Pub. No.: US 2026/0055898 A1
(43) Pub. Date: Feb. 26, 2026

(54) COOKTOP APPLIANCE HAVING A REMOVABLE GRIDDLE ASSEMBLY AND SENSORS THEREFOR

(71) Applicant: Haier US Appliance Solutions, Inc., Wilmington, DE (US)

(72) Inventors: Paul Bryan Cadima, Crestwood, KY (US); Aaron Zarate-Hernandez, Louisville, KY (US)

(21) Appl. No.: 18/809,956

(22) Filed: Aug. 20, 2024

(51) Int. Cl. F24C 3/12; A47J 36/32; A47J 37/06; F24C 15/10; G05D 23/20

(52) U.S. Cl. CPC F24C 3/12; A47J 36/32; A47J 37/0682; F24C 15/108; G05D 23/20

(57) ABSTRACT

A cooking appliance includes a heating element, a controller configured to operate the heating element, and a plate comprising a top cooking surface. The top cooking surface extends perpendicular to the vertical direction to receive a cooking item thereon. The cooking appliance also includes a temperature probe. The temperature probe is in signal communication with the controller. The temperature probe is spring-loaded, and the temperature probe includes an integrated circuit switch.

### FIELD OF THE INVENTION

The present subject matter relates generally to cooking appliances, and more particularly to cooktop appliances and sensors therefor.

### BACKGROUND OF THE INVENTION

Cooking appliances, e.g., cooktops or ranges (also known as hobs or stoves), generally include one or more heated portions for heating or cooking food items within or on a cooking utensil placed on the heated portion. For instance, each heated portion may be provided as burners, resistive heating elements, inductive heating elements, or radiant heaters may be included with each heated portion. The heated portions utilize one or more heating sources to output heat, which is transferred to the cooking utensil and thereby to any food item or items that are positioned on or within the cooking utensil. For instance, a griddle may be provided to extend across one or more heated portions. When positioned above the heated portion, the griddle generally provides a substantially flat cooking surface.

It may frequently be desirable to facilitate a closed loop cooking cycle with removable cooking utensils such as a griddle, e.g., by monitoring the temperature of the griddle and adjusting the heating elements to maintain the desired griddle temperature. Although some assemblies have incorporated temperature sensors directly into a griddle, such assemblies may be difficult to clean and have difficulties in ensuring precise or accurate temperature measurements. If connected wirelessly, the assembly cost and complexity may be greatly increased. Other assemblies have attempted to mount temperature sensors in or near a heating element, but unwanted convective heat transfer can significantly harm precision or accuracy of the temperature sensors. Moreover, high heat caused by proximity to the heating element can cause damage. In turn, most griddles with temperature detection features are often non-removable from the appliance. Moreover, user removable griddles are commonly not placed or aligned perfectly by users of the cooktop, thereby potentially positioning any removable temperature probe such that electronics and heat sensitive parts are in a direct heating path of the heating assemblies. Additionally, allocating multiple inputs, such as temperature, knob position, griddle position, and operation mode, into a control board may increase cost and complexity of the cooking appliance.

Accordingly, a cooking appliance including a user removable griddle with temperature measuring capabilities while reducing the number of inputs to the control board would be useful. More specifically, a temperature probe that may be conveniently used with a removable griddle on a gas cooktop while avoiding excessive temperature exposure and reducing the number of inputs to the control board would be particularly beneficial.

### BRIEF DESCRIPTION OF THE INVENTION

Aspects and advantages of the invention will be set forth in part in the following description, or may be obvious from the description, or may be learned through practice of the invention.

In one example aspect of the present disclosure, a cooktop appliance is provided. The cooktop appliance defines a vertical direction, a lateral direction, and a transverse direction. The vertical, lateral, and transverse directions are mutually perpendicular. The cooktop appliance includes a top panel, a heating element attached to the top panel, a controller configured to operate the heating element, and a griddle plate selectively disposable in a griddle-cook position above the top panel along the vertical direction. The griddle plate includes a top cooking surface. The top cooking surface extends perpendicular to the vertical direction in the griddle-cook position to receive a cooking item thereon. The cooktop appliance also includes a temperature probe attached to the top panel and horizontally spaced apart from the heating element. The temperature probe is in signal communication with the controller. The temperature probe is spring-loaded away from the top panel, and the temperature probe includes an integrated circuit switch.

In another example aspect of the present disclosure, a cooking appliance is provided. The cooking appliance defines a vertical direction, a lateral direction, and a transverse direction. The vertical, lateral, and transverse directions are mutually perpendicular. The cooking appliance includes a heating element, a controller configured to operate the heating element, and a plate comprising a top cooking surface. The top cooking surface extends perpendicular to the vertical direction to receive a cooking item thereon. The cooking appliance also includes a temperature probe. The temperature probe is in signal communication with the controller. The temperature probe is spring-loaded, and the temperature probe includes an integrated circuit switch.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a top plan view of a cooktop appliance according to example embodiments of the present disclosure.

FIG. 2 provides a sectional perspective view of a portion of the example cooktop appliance of FIG. 1, wherein a griddle assembly is provided in a griddle-cook position.

FIG. 3 provides a magnified perspective view of a portion of the example cooktop appliance of FIG. 1.

FIG. 4 provides an exploded perspective view of a portion of the example cooktop appliance of FIG. 1.

FIG. 5 provides a perspective view of a portion of a temperature sensor of a cooktop appliance according to example embodiments of the present disclosure.

FIG. 6 provides a sectional perspective view of the example temperature sensor of FIG. 5 within an example cooktop appliance.

FIG. 7 provides a perspective view of an example temperature sensor according to example embodiments of the present disclosure, wherein the temperature sensor is provided in the UP position.

FIG. 8 provides a sectional perspective view of the temperature sensor of FIG. 7, wherein the temperature sensor is provided in the UP position.

FIG. 9 provides a perspective view of the temperature sensor of FIG. 7, wherein the temperature sensor is provided in the DOWN position.

FIG. 10 provides a sectional perspective view of the temperature sensor of FIG. 7, wherein the temperature sensor is provided in the DOWN position.

FIG. 11 provides an example electrical diagram according to example embodiments of the present disclosure.

FIG. 12 illustrates another example electrical diagram according to example embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “include(s)” and “including” are intended to be inclusive in a manner similar to the term “comprising. ” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise, or counterclockwise, with the vertical direction V.

The word “example” is used herein to mean “serving as an example, instance, or illustration. ” In addition, references to “an embodiment” or “one embodiment”does not necessarily refer to the same embodiment, although it may. Any implementation described herein as “example” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure may include a cooktop appliance that has a griddle assembly that can be removably placed over one or more heating assemblies. For instance, the griddle assembly may be placed on a top panel in place of a removable grate assembly. A temperature sensor fixed to the top panel may contact the griddle assembly and detect the temperature at the same. Notably, the temperature sensor may be protected from excessive heat or heat that might otherwise harm accuracy or precision. Additionally or alternatively, the temperature sensor may be prevented from contacting or detecting temperature readings for the removable grate assembly, even when the grate assembly replaces the griddle assembly on the top panel. Furthermore, the temperature sensor may also detect the presence/position of the griddle assembly.

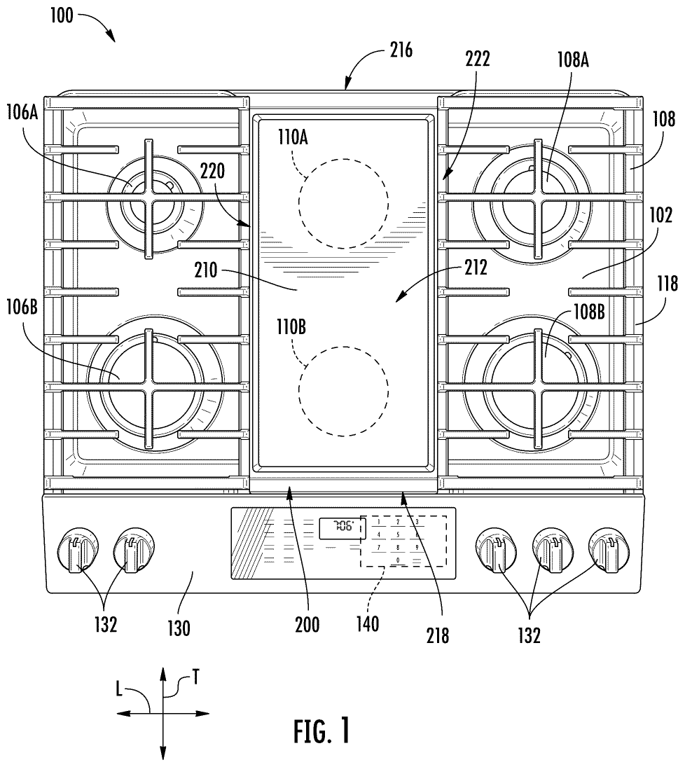

Turning now to the figures, FIG. 1 provides a top view of a cooktop appliance 100 having a griddle assembly 200, wherein the griddle assembly 200 is in a griddle-cook position. In general, griddle assembly 200 may be formed from any material that is suitably rigid and suitable for high temperature cooking operations. In this regard, for example, griddle assembly 200 may be formed from a nonferrous material, such as aluminum alloy. According to still other embodiments, griddle assembly 200 may be formed from a ferrous material, such as cast iron or stainless steel. Other materials and griddle constructions are possible and within the scope of the present subject matter.

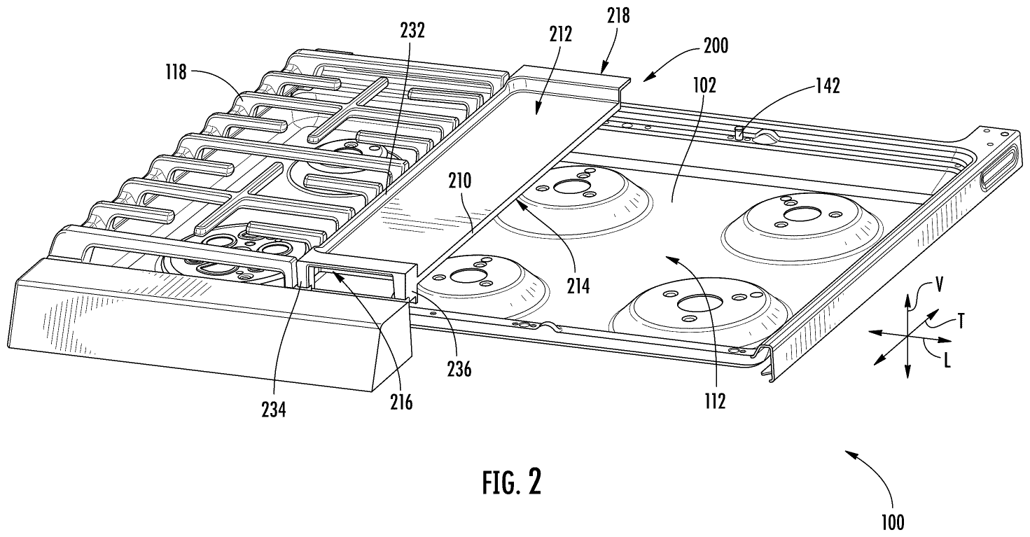

FIGS. 2 through 4 provide various views of the cooktop appliance 100, as shown in FIG. 1, wherein portions of the heating elements and user interface have been removed for clarity. Generally, cooktop appliance 100 defines a vertical direction V, a lateral direction L, and a transverse direction T. Each of the vertical direction V, lateral direction L, and transverse direction T may be mutually orthogonal to each other.

Cooktop appliance 100 generally includes one or more heating elements, e.g., heating elements 106A, 106B, 108A, 108B, 110A, 110B. Although heating elements 106A, 106B, 108A, 108B, 110A, 110B are shown as being gas burners, other embodiments may include radiant heating elements, induction heating elements, resistive heating elements, or other suitable heating elements. When assembled, cooktop appliance 100 may be installed at any suitable location. For example, cooktop appliance 100 may be mounted to a countertop and used as a standalone cooktop appliance in certain embodiments. In other example embodiments, cooktop appliance 100 may be utilized in a range appliance. In addition, while described in greater detail below in the context of cooktop appliance 100, it should be understood that the present subject matter may be used in any other suitable cooktop appliance in alternative example embodiments. Thus, cooktop appliance 100 is provided by way of example only and is not intended to limit the present subject matter to any particular arrangement or configuration.

As shown, cooktop appliance 100 includes top panel 102 with an outer surface 112. Top panel 102 may be constructed of or with any suitable material. For example, top panel 102 may be constructed of or with enameled steel or ceramic. Top panel 102 may also have any suitable shape. For example, top panel 102 may be rectangular or square, e.g., in a plane that is perpendicular to the vertical direction V.

A plurality of heating elements 106A, 106B, 108A, 108B, 110A, 110B (e.g., as a plurality of gas burners) is attached to top panel 102. For instance, one or more of heating elements 106A, 106B, 108A, 108B, 110A, 110B may be mounted to top panel 102 and positioned at outer surface 112 of top panel 102. Each heating element of heating elements 106A, 106B, 108A, 108B, 110A, 110B may have any suitable shape and size, and a combination of variously sized or shaped heating elements may be provided in order to facilitate heating of a variety of cooking utensils.

As shown, the cooktop appliance 100 may include a first heating element 110A disposed on the top panel 102 and a second heating element 110B spaced apart from the first heating element 110A on the top panel 102. For example, as illustrated, the first heating element 110A and the second heating element 110B may be aligned along the transverse direction T. The top panel 102 may also include a recessed portion, e.g., which extends downward along the vertical direction V. The first heating element 110A and the second heating element 110B may be positioned within the recessed portion. The recessed portion may collect spilled material, e.g., foodstuffs, during operation of the cooktop appliance 100.

According to the illustrated example embodiment, a user interface panel or control panel 130 is located within convenient reach of a user of cooktop appliance 100. For this example embodiment, control panel 130 includes control knobs 132 that are each associated with one of heating elements 106A, 106B, 108A, 108B, 110A, 110B. Control knobs 132 allow the user to activate each heating element 106A, 106B, 108A, 108B, 110A, 110B and regulate the amount of heat input that each heating element 106A, 106B, 108A, 108B, 110A, 110B provides (e.g., to a cooking utensil located thereon). Although cooktop appliance 100 is illustrated as including control knobs 132 for controlling heating elements 106A, 106B, 108A, 108B, 110A, 110B, it will be understood that control knobs 132 and the configuration of cooktop appliance 100 shown in FIG. 1 is provided by way of example only. More specifically, control panel 130 may include various input components, such as one or more of a variety of touch-type controls, electrical, mechanical, or electro-mechanical input devices including rotary dials, push buttons, and touch pads.

According to the illustrated embodiment, control knobs 132 are located within control panel 130 of cooktop appliance 100. However, it should be appreciated that this location is used only for the purpose of explanation, and that other locations and configurations of control panel 130 and control knobs 132 are possible and within the scope of the present subject matter. Indeed, according to alternative embodiments, control knobs 132 may instead be located directly on top panel 102 or elsewhere on cooktop appliance 100, e.g., on a backsplash, front bezel, or any other suitable surface of cooktop appliance 100. Control panel 130 may also be provided with one or more graphical display devices, such as a digital or analog display device designed to provide operational feedback to a user.

Referring again to FIG. 1, operation of the cooktop appliance 100 may be regulated by a controller 140 that is operably coupled to (i.e., in operative communication with) the user inputs (e.g., control knobs 132) or heating elements 106A, 106B, 108A, 108B, 110A, 110B. In this regard, control panel 130, control knobs 132, and other suitable inputs/outputs may be in communication with controller 140 such that controller 140 may regulate operation of cooktop appliance 100. For example, signals generated by controller 140 may operate cooktop appliance 100, including any or all system components, subsystems, or interconnected devices, in response to the position of control knobs 132 and other control commands. Control panel 130 and other components of cooktop appliance 100 may be in communication with controller 140 via, for example, one or more signal lines or shared communication busses. In this manner, Input/Output (“I/O”) signals may be routed between controller 140 and various operational components of cooktop appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 140 may be constructed without using a microprocessor, e.g., using a combination of discrete analog or digital logic circuitry (such as switches, amplifiers, integrators, comparators, flip-flops, OR gates, and the like) to perform control functionality instead of relying upon software.

Controller 140 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information or data accessible by the one or more processors, including instructions that can be executed by the one or more processors. It should be appreciated that the instructions can be software written in any suitable programming language or can be implemented in hardware. Additionally, or alternatively, the instructions can be executed logically or virtually using separate threads on one or more processors.

For example, controller 140 may be operable to execute programming instructions or micro-control code associated with an operating cycle of cooktop appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 140 as disclosed herein is capable of and may be operable to perform any methods, method steps, or portions of methods as disclosed herein. For example, in some embodiments, methods disclosed herein may be embodied in programming instructions stored in the memory and executed by controller 140.

The memory devices may also store data that can be retrieved, manipulated, created, or stored by the one or more processors or portions of controller 140. The data can include, for instance, data to facilitate performance of methods described herein. The data can be stored locally (e.g., on controller 140) in one or more databases or may be split up so that the data is stored in multiple locations. In addition, or alternatively, the one or more database(s) can be connected to controller 140 through any suitable network(s), such as through a high bandwidth local area network (LAN) or wide area network (WAN). In this regard, for example, controller 140 may further include a communication module or interface that may be used to communicate with one or more other component(s) of cooktop appliance 100, controller 140, an external appliance controller, or any other suitable device (e.g., via any suitable communication lines or network(s) and using any suitable communication protocol). The communication interface can include any suitable components for interfacing with one or more network(s), including for example, transmitters, receivers, ports, controllers, antennas, or other suitable components.

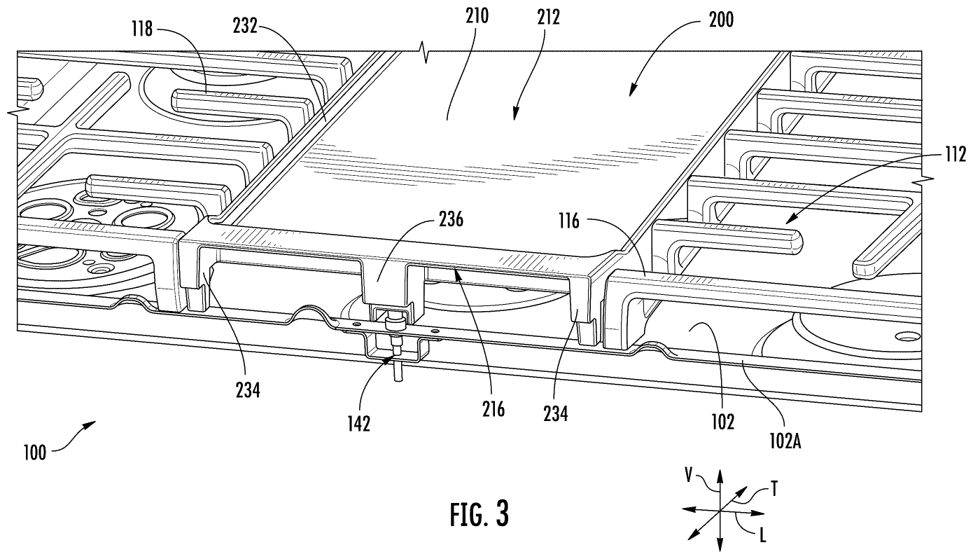

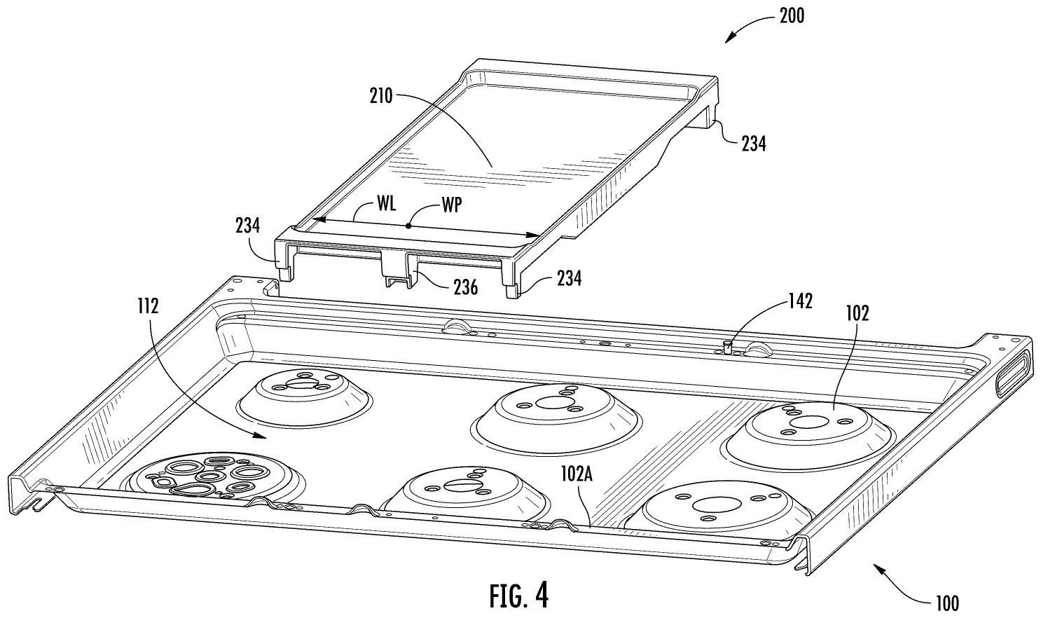

In some embodiments, controller 140 is in operative (e.g., wired or wireless) communication with a temperature probe 142. As shown, temperature probe 142 is mounted (e.g., fixedly mounted) on or relative to top panel 102. For instance, temperature probe 142 may be attached to a peripheral rim 102A (FIG. 3) of top panel 102. Thus, temperature probe 142 may be horizontally spaced apart from each of the heating elements 106A, 106B, 108A, 108B, 110A, 110B. Additionally or alternatively, temperature probe 142 may be mounted outside (e.g., horizontally apart from) or above the recessed portion of top panel 102. In some example embodiments, such as is shown in FIGS. 2 and 4, temperature probe 142 may be disposed at a rear portion of top panel 102 (e.g., opposite from the control panel 130 relative to the transverse direction T).

Generally, temperature probe 142 is operable to measure a temperature of the cooking utensil on griddle assembly 200. To that end, temperature probe 142 may be provided as any suitable temperature-detecting element. For instance, temperature probe 142 may include or be provided as a thermistor, a thermocouple, a resistance temperature detector, a semiconductor-based integrated circuit temperature sensor, etc. During use, temperature probe 142 may output a signal, such as a voltage, to controller 140 that is proportional to or otherwise indicative of the temperature being measured. Although example positioning of a temperature probe is described herein, it should be appreciated that cooktop appliance 100 may include any other suitable number, type, and position of temperature probes according to alternative embodiments.

In some embodiments, cooktop appliance 100 may be configured for closed-loop cooking. For example, controller 140 may be operable to receive a set temperature (such as from a user input of the cooktop appliance 100 or wirelessly from a remote device such as a smartphone) and compare the set temperature to temperature measurements from temperature probe 142, which may detect the temperature of griddle assembly 200 as generated by one or more heating elements (e.g., 110A, 110B). Controller 140 may be further programmed to automatically adjust each corresponding heating element 110A, 110B, such as a fuel flow rate to each burner, based on the comparison of the corresponding temperature measurement to the set temperature.

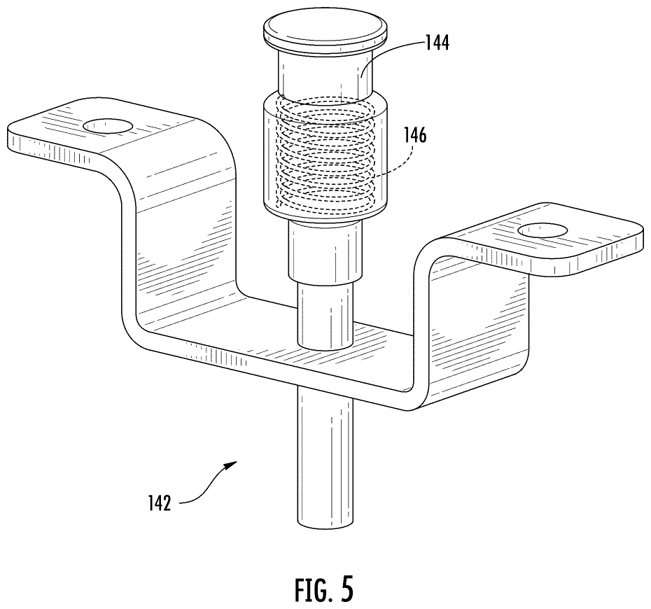

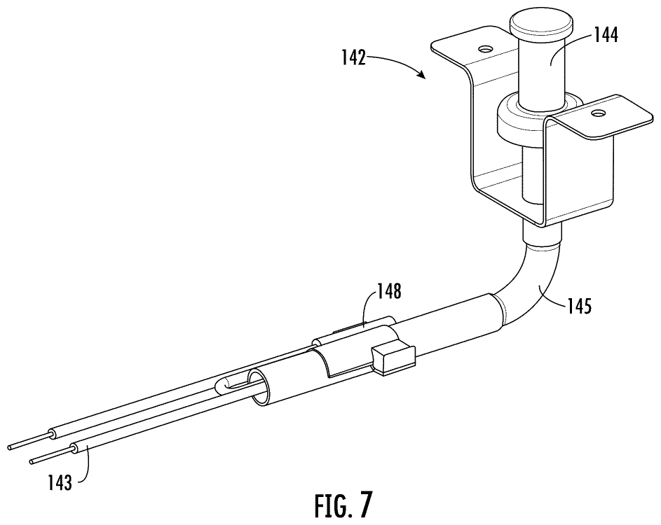

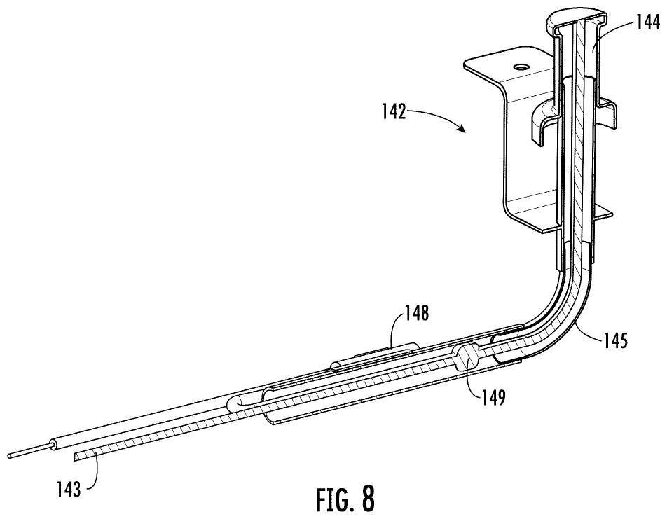

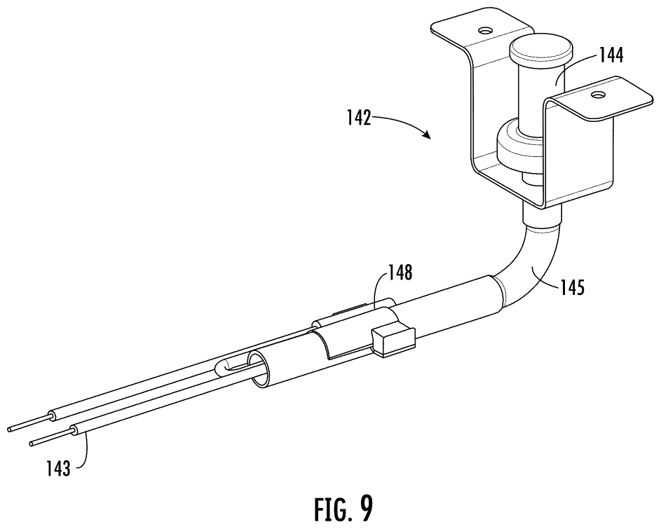

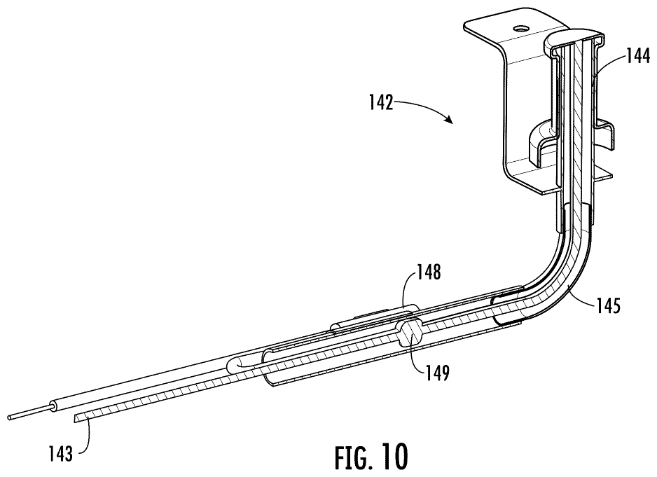

As best seen in FIG. 5, temperature probe 142 may include a conductive rod 144 extending (e.g., vertically) above top panel 102. Referring now generally to FIGS. 1 through 5, in some embodiments, temperature probe 142 is spring-loaded away from the top surface of top panel 102 (e.g., upward). In particular, a compression spring 146 mounted within the sensor body of temperature probe 142 (e.g., as is generally understood) may bias the conductive rod 144 upward. Moreover, temperature probe 142 may be vertically movable relative to the top surface of top panel 102 between a relatively low, compressed position (e.g., FIGS. 9 and 10) and a relatively high, uncompressed position (e.g., FIGS. 7 and 8). As will be explained further below, a circuit switch 148 may be coupled (e.g., mechanically coupled) with temperature probe 142 to detect the temperature probe 142 in the compressed position (e.g., when in contact or conductive thermal communication with a separate member, such as griddle assembly 200). For instance, circuit switch 148 may move (e.g., close) in response to detection or placement of the temperature probe 142 in the compressed position. Additionally or alternatively, the circuit switch 148 may close a circuit connecting temperature probe 142 to the controller 140. In turn, measurement of the temperature at temperature probe 142 may be prevented or prohibited in the uncompressed position of circuit switch 148.

As will be explained in greater detail below, griddle assembly 200 may be selectively disposed on top panel 102 over one or more heating elements, such as 110A, 110B. Separate from or in addition to griddle assembly 200, however, one or more grates may be positioned on top panel 102 at outer surface 112 of top panel 102 (e.g., in place of griddle assembly 200). Grates may include a first grate 116 (or pair of grates) and/or a second grate 118 positioned on top panel 102. When assembled, first grate 116 may be positioned over element 106A and element 106B, second grate 118 is positioned over element 108A and element 108B, and, in some example embodiments, a third grate (not shown) may be selectively positioned over elements 110A, 110B (e.g., in a grate-cook position or in place of griddle assembly 200). Generally, grates 116, 118 are removable from top panel 102. For example, a user of cooktop appliance 100 may lift grates 116, 118 upwardly to remove grates 116, 118 from top panel 102.

As noted above, cooktop appliance 100 includes a griddle assembly 200. Griddle assembly 200 is generally removable from top panel 102. For instance, during use (e.g., in a griddle-cook position), griddle assembly 200 may rest (or be disposed) directly on top panel 102 (e.g., such that a third grate (not shown) and griddle assembly 200 are interchangeable on top panel 102).

Generally, griddle assembly 200 defines a vertical direction, a lateral direction, and a transverse direction. The vertical direction, lateral direction, and transverse direction defined by griddle assembly 200 are all mutually perpendicular and form a secondary orthogonal direction system. When griddle assembly 200 is disposed on top panel 102, the secondary orthogonal system may be considered parallel to the primary orthogonal system, including vertical direction V, later direction L, and transverse direction T, defined by the cooktop appliance 100 as a whole. Thus, although the orientation of griddle assembly 200 may vary with respect to the rest of cooktop appliance 100 (e.g., when the griddle assembly 200 is not in the griddle-cook position), griddle assembly 200 will be described as positioned during use, e.g., in the griddle-cook position) and with respect to vertical direction V, lateral direction L, and transverse direction T.

Griddle assembly 200 includes an upper griddle plate 210 that may be positioned over top panel 102, e.g., along the vertical direction V. Griddle plate 210 defines a top cooking surface 212 and a bottom heating surface 214 below and beneath top cooking surface 212. As shown, griddle plate 210 (and griddle assembly 200 generally) extends along the transverse direction between a rear griddle end 216 and a front griddle end 218 and along the lateral direction between a first griddle side 220 and a second griddle side 222. In example embodiments, griddle plate 210 is a generally planar member. In turn, top cooking surface 212 may be a substantially flat surface. Moreover, one or both of top cooking surface 212 and bottom heating surface 214 may extend perpendicular to the vertical direction V. Griddle plate 210 may have any suitable shape. For example, griddle plate 210 may be substantially rectangular or square, e.g., in a plane that is perpendicular to the vertical direction V.

As shown, griddle assembly 200 may be selectively positioned above one or more of the heating elements 110A, 110B. For instance, griddle assembly 200 may be placed on top panel 102 above heating elements 110A, 110B. During use, top cooking surface 212 faces away from top panel 102 to receive a cooking item thereon. By contrast, bottom heating surface 214 may be opposite from top cooking surface 212 and faces top panel 102 during use. Thus, bottom heating surface 214 may face top panel 102 to receive a thermal output, e.g., flame or heated air, from heating element 110A, 110B.

In certain embodiments, a containment rim 232 extends along at least a portion of the perimeter of griddle plate 210. For instance, containment rim 232 may extend (e.g., continuously, or uninterrupted) vertically upward (e.g., from top cooking surface 212) and horizontally along the first griddle side 220, rear griddle end 216, second griddle side 222, or front griddle end 218. Containment rim 232 may shield or at least partially enclose top cooking surface 212. Optionally, containment rim 232 may be formed integrally (i.e., as a monolithic unitary member) with griddle plate 210 or another portion of griddle assembly 200. For instance, griddle assembly 200, including containment rim 232 and griddle plate 210, may be integrally formed from a suitable thermal conductive metal.

Separate from or in addition to containment rim 232, griddle assembly 200 may include one or more support posts 234, 236 extending downward (e.g., along the vertical direction V) from griddle plate 210 (e.g., at bottom heating surface 214). For instance, multiple passive posts 234 may extend downward to rest on top panel 102 and hold griddle plate 210 above the same. In certain embodiments, at least one support post is provided as an active post 236 in selective contact or conductive thermal communication with the temperature probe 142 (e.g., in the griddle-cook position). For instance, active post 236 may be located at a periphery of griddle plate 210. In other words, active post 236 may be disposed at a horizontal perimeter of the griddle plate 210 (e.g., at rear griddle end 216 or directly beneath a portion of containment rim 232). Optionally, the griddle plate 210 (or griddle assembly 200 generally) may define a lateral width WL having a lateral midpoint WP at which the active post 236 may generally be aligned relative to the lateral direction L (e.g., for even or consistent heat distribution to active post 236). In general, any one of support posts 234 may be an active post 236, depending on the position of temperature probe 142 at top panel 102, and active post 236 as described herein is provided by way of example only and is not intended to limit the present subject matter to any particular arrangement or configuration.

In the griddle-cook position, active post 236 may be vertically aligned with temperature probe 142. Advantageously, at least a portion of the active post 236 may extend over and above temperature probe 142 when griddle assembly 200 is properly received on top panel 102. For example, active post 236 may define a probe notch (not shown) within which temperature probe 142 may be received (e.g., in the griddle-cook position). Thus, in some example embodiments, temperature probe 142 may be at least partially enclosed. In general, active post 236 may contact conductive rod 144 (e.g., to motivate temperature probe 142 to the compressed position), thus, in the griddle-cook position, compressing or resting on temperature probe 142, advantageously providing a detectable indication of griddle assembly 200 in the griddle-cook position, as will be described in further detail below.

In the griddle-cook position, at least one grate may be spaced apart from top panel 102 (e.g., removed therefrom, such as for storage in another room from the rest of cooktop appliance 100). By contrast, in the grate-cook position, the grate may be disposed in the same region previously or otherwise occupied by the griddle assembly 200. Thus, in the grate-cook position, griddle assembly 200 may be spaced apart from top panel 102 (e.g., removed therefrom, such as for storage in another room from the rest of cooktop appliance 100).

Notably, the example appliances and griddle assemblies described herein may maintain conductive communication with the temperature probe, thus, advantageously, consistent and/or accurate temperature measurements may be obtained for the griddle assembly during use. Additionally or alternatively, the griddle assembly may be selectively removed (e.g., to be replaced by a swappable grate). Further additionally or alternatively, the above-described cooktop appliance (e.g., having a fixed temperature sensor with a removable griddle assembly) may be relatively easy to clean and ensure proper functioning or alignment (e.g., for a temperature probe).

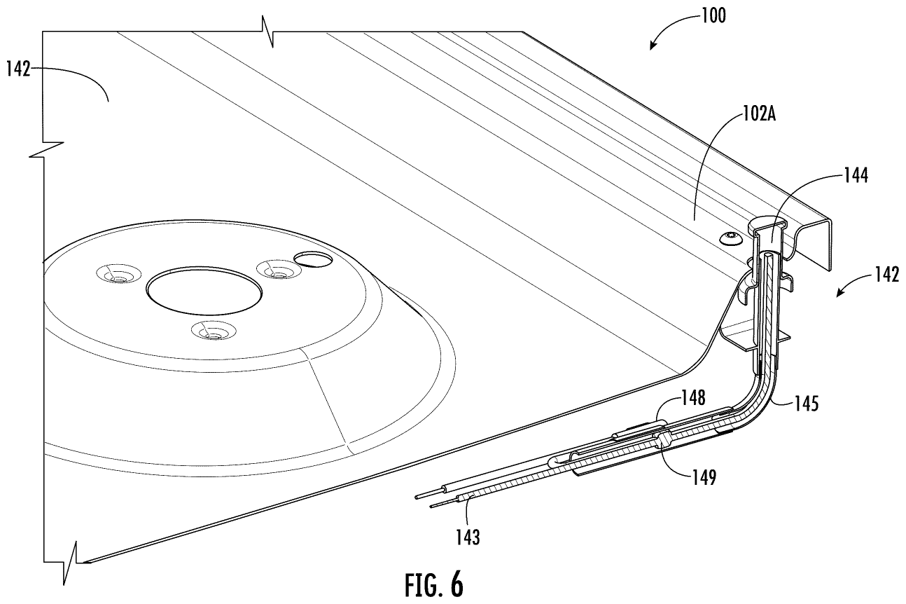

Referring now generally to FIGS. 6 through 10, provided are various perspective views of temperature probe 142. As seen in FIG. 6, conductive rod 144 may extend above top panel 102, and a sleeve 145 may extend (e.g., vertically) beneath top panel 102. In general, sleeve 145 may cover/house output wire 143 between temperature probe 142 and controller 140. As stated above, circuit switch 148 may be coupled (e.g., mechanically coupled) with temperature probe 142 to detect the temperature probe 142 in the compressed position. In particular, circuit switch 148 may be an integrated circuit switch with temperature probe 142, such that two (2) inputs (e.g., position and temperature) may be transmitted to controller 140 in one (1) output. For example, circuit switch 148 may be a reed sensor, wherein a magnet 149 may be disposed on output wire 143 within sleeve 145. In general, magnet 149 may be configured to translate within sleeve 145 to trigger circuit switch 148 when the temperature probe 142 is moved to the compressed position (e.g., the griddle assembly 200 is placed thereon).

Referring generally to FIGS. 7 and 8, temperature probe 142 is illustrated in an UP position. In particular, compression spring 146 (FIG. 5) may bias the conductive rod 144 upward, e.g., upward generally along the vertical direction V away from and above the top panel 142, thus pulling output wire 143 and thereby magnet 149, horizontally separating magnet 149 from circuit switch 148. Accordingly, in the UP position, circuit switch 148 may be open, thereby limiting, preventing, and/or prohibiting measurement of the temperature at temperature probe 142 while in the uncompressed UP position.

Referring generally to FIGS. 9 and 10, temperature probe 142 is provided in a DOWN position. For example, when in contact or conductive thermal communication with a separate member, such as griddle assembly 200, temperature probe 142 may move into the compressed DOWN position. For instance, the compression of compression spring 146 (FIG. 5) may push output wire 143 through sleeve 145, such that magnet 149 engages circuit switch 148 (e.g., magnetically, as would be understood). As such, circuit switch 148 may move (e.g., close) in response to detection or placement of the temperature probe 142 in the compressed position. Thus, when temperature probe 142 is in contact or conductive thermal communication with a separate member, circuit switch 148 may close, thereby connecting temperature probe 142 to the controller 140. Accordingly, in the DOWN position, circuit switch 148 may be closed, thereby transmitting two (2) inputs (e.g., position and temperature) to controller 140 in one (1) output through output wire 143.

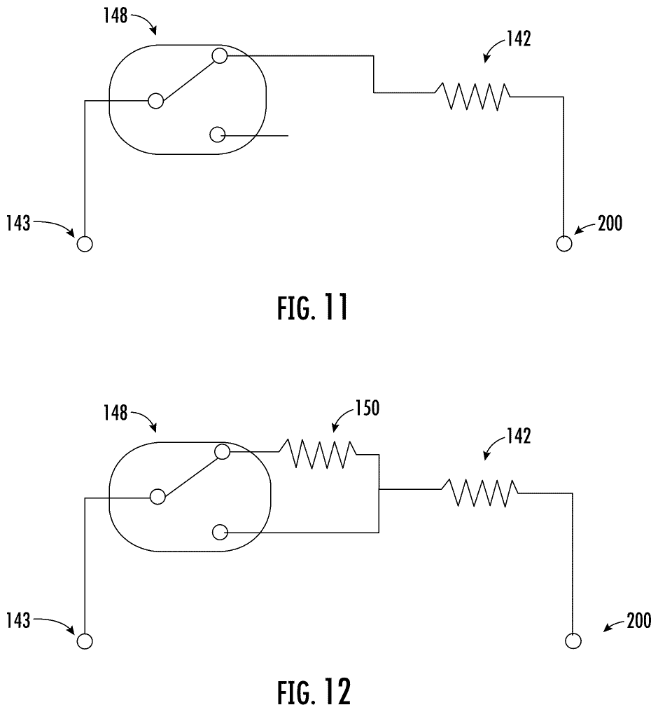

Referring now to FIGS. 11 and 12, provided are example embodiments of electrical diagrams of an example temperature probe and integrated circuit switch. In general, circuit switch 148 may be wired in series with temperature probe 142 such that one unified output is summed and transmitted to controller 140 as opposed to two independent signal channels being input into controller 140 individually. Thus, controller 140 may determine the presence of griddle assembly 200 by measuring a resistance within a specified threshold corresponding to temperature probe 142 (e.g., between zero kilohms (0 kOhm) and two hundred and fifty kilohms (250 kOhm), depending on the temperature), or controller 140 may measure an open circuit when temperature probe 142 is in the uncompressed UP position (e.g., griddle assembly 200 nor a grate is present). In other words, only one output from temperature probe 142 (e.g., through output wire 143) provides both sets of information to controller 140.

Referring specifically to FIG. 12, circuit switch 148 may include a resistor 150 coupled in series with temperature probe 142. In general, resistor 150 may have a different resistance than that of temperature probe 142. In particular, the resistance of temperature probe 142 may generally be between zero kilohms (0 kOhm) and two hundred and fifty kilohms (250 kOhm) and resistor 150 may include a resistance 30%, 50%, or 100% larger than the resistance of temperature probe 142. For example, the resistance of resistor 150 may be three hundred and seventy five kiloohms (375 kOhm), five hundred kilohms (500 kOhm), or seven hundred and fifty kilohms (750 kOhm), etc. In other words, a resistance value of resistor 150 may be greater than a resistance value of temperature probe 142, such that controller 140 may be configured to detect a status (e.g., temperature, position of griddle/grate) of the cooktop appliance 100, depending upon a summation of the resistance values. As such, controller 140 may receive an output from temperature probe 142 which is a sum of a resistance value of the temperature and of the resistor 150 coupled in series, whereby the sum of the resistance is indicative of the of the position of griddle assembly 200 and the temperature of griddle assembly 200.

In the present example embodiment, controller 140 may determine griddle assembly 200 is present by measuring resistance corresponding to an expected range of a series sum, e.g., the summation of the resistance of temperature probe 142 and the resistance of resistor 150. For example, if griddle assembly 200 is not present, the summation of the resistance would measure within a range expected for only temperature probe 142, but if griddle assembly 200 is present, the summation of the resistance would measure within a range of both temperature probe 142 and resistor 150.

Advantageously however, if temperature probe 142 has failed, controller 140 may be configured to detect a fault in the temperature probe 142 as the resistance would measure open. Accordingly, three (3) conditions (e.g., temperature probe function, temperature, and position) may be determined using only a singular output to controller 140, thus reducing overall system costs and complexity.

As stated above, cooktop appliance 100 may be configured for closed-loop cooking. During the closed loop cooking process, temperature measurements from temperature probe 142 may indicate the temperature of griddle assembly 200 as heat is generated by one or more heating elements (e.g., 110A, 110B). Controller 140 may be further programmed to automatically adjust each corresponding heating element 110A, 110B, such as a fuel flow rate to each burner, based on the singular output from temperature sensor 142, in comparison with the set temperature.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooktop appliance defining a vertical direction, a lateral direction, and a transverse direction, the vertical, lateral, and transverse directions being mutually perpendicular, the cooktop appliance comprising:
a top panel;
a heating element attached to the top panel;
a controller configured to operate the heating element;
a griddle plate selectively disposable in a griddle-cook position above the top panel along the vertical direction, the griddle plate comprises a top cooking surface, the top cooking surface extending perpendicular to the vertical direction in the griddle-cook position to receive a cooking item thereon; and
a temperature probe attached to the top panel and horizontally spaced apart from the heating element, the temperature probe in signal communication with the controller, the temperature probe spring-loaded away from the top panel, the temperature probe comprising an integrated circuit switch.

2. The cooktop appliance of claim 1, wherein when the griddle plate is in the griddle-cook position, the griddle plate is configured to contact the temperature probe, whereby the integrated circuit switch is selectively opened or closed according to the contact between the temperature probe and the griddle plate.

3. The cooktop appliance of claim 1, wherein the temperature probe and the integrated circuit switch are coupled in series such that a singular output is transmitted from the temperature probe to the controller.

4. The cooktop appliance of claim 3, further comprising a resistor coupled in series with the integrated circuit switch.

5. The cooktop appliance of claim 4, wherein a resistance value of the resistor is greater than a resistance value of the temperature probe, wherein the controller is configured to detect a status of the cooktop appliance depending upon a sum of the resistance values.

6. The cooktop appliance of claim 1, wherein a support post is disposed at a horizontal perimeter of the griddle plate, the support post configured to engage the temperature probe.

7. The cooktop appliance of claim 6, wherein the griddle plate extends transversely between a front griddle end and a rear griddle end, and wherein the support post is disposed at the rear griddle end.

8. The cooktop appliance of claim 6, wherein the griddle plate defines a lateral width having a lateral midpoint, and wherein the support post is aligned with the lateral midpoint relative to the lateral direction.

9. The cooktop appliance of claim 1, wherein the heating element is a first heating element, and wherein the cooktop appliance further comprises a second heating element horizontally spaced apart from the first heating element and disposed directly below the griddle plate in the griddle-cook position.

10. A cooking appliance defining a vertical direction, a lateral direction, and a transverse direction, the vertical, lateral, and transverse directions being mutually perpendicular, the cooking appliance comprising:
a heating element;
a controller configured to operate the heating element;
a plate comprising a top cooking surface, the top cooking surface extending perpendicular to the vertical direction to receive a cooking item thereon; and
a temperature probe, the temperature probe in signal communication with the controller, the temperature probe spring-loaded, the temperature probe comprising an integrated circuit switch.

11. The cooking appliance of claim 10, wherein the plate is configured to contact the temperature probe, whereby the integrated circuit switch is selectively opened or closed according to the contact between the temperature probe and the plate.

12. The cooking appliance of claim 10, wherein the temperature probe and the integrated circuit switch are coupled in series such that a singular output is transmitted from the temperature probe.

13. The cooking appliance of claim 12, further comprising a resistor coupled in series with the integrated circuit switch.

14. The cooking appliance of claim 13, wherein a resistance value of the resistor is greater than a resistance value of the temperature probe, wherein the controller is configured to detect a status of the cooking appliance depending upon a sum of the resistance values.

15. The cooking appliance of claim 10, wherein a support post is disposed at a horizontal perimeter of the plate, the support post configured to engage the temperature probe.

16. The cooking appliance of claim 15, wherein the plate extends transversely between a front end and a rear end, and wherein the support post is disposed at the rear end.

17. The cooking appliance of claim 15, wherein the plate defines a lateral width having a lateral midpoint, and wherein the support post is aligned with the lateral midpoint relative to the lateral direction.

18. The cooking appliance of claim 10, wherein the heating element is a first heating element, and wherein the cooking appliance further comprises a second heating element spaced apart from the first heating element and disposed directly below the plate.
